(19) United States
(12) Patent Application Publication
(10) Pub. No.: US 2005/0112918 A1
(43) Pub. Date: May 26, 2005

(54) Electrical connector

(76) Inventors: Yi-Chung Su, Tu-Chen (TW); Hsin Kuo Dai, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/993,618

(22) Filed: Nov. 19, 2004

(30) Foreign Application Priority Data
Nov. 21, 2003 (TW) 92220592

(51) Int. Cl. H01R 12/00

(52) U.S. Cl. 439/79

(57) ABSTRACT

An electrical connector (1) used in high frequency signal transmission filed includes an insulative housing (2), an immovable contact (5) retained in the housing. The immovable contact includes a main body (50), a cantilevered arm (51) longitudinally extending from the main body, a soldering portion (53) backwardly extending from the main body. The cantilevered arm forms an angle to the main body. The main body is a substantially “Z” shape to prolong the current path of the immovable contact and to cut the area of the immovable contact, thereby decreasing the capacity of the immovable contact.

### BACKGROUND OF THE INVENTION

1. Field of the Invention

This invention generally relates to an electrical connector and more particularly, to an electrical connector used in high frequency signal transmission.

2. Description of the Prior Art

In high frequency transmission field, an increased demand of high transmission performance is needed. FIG. 1 shows a plan view of a contact 6 used in a conventional electrical connector. The contact 6 includes a main body 8, a cantilevered beam 7 longitudinally extending from the main body 8, a soldering portion 9 backwardly extending from the main body 8. The main body 8 is substantially rectangular shaped. As a result, the current path is relatively short when the current goes through the contact. Therefore, the capacity of the contact is relatively high to impair the transmission performance of the conventional electrical connector.

Hence, an improved electrical connector is desired to overcome the above problems and meet the increasing transmission demand.

### BRIEF SUMMARY OF THE INVENTION

It is an object of the present invention to provide an electrical connector with good electrical characteristics.

In order to attain the object above, an electrical connector used in the high frequency transmission field according to the present invention includes an insulative housing, an immovable contact retained in the housing. The immovable contact includes a main body, a cantilevered arm longitudinally extending from the fixing portion, a soldering portion backwardly extending from the main body. The cantilevered arm forms an angle with the main body. The main body is a substantially “Z” shape which is in favor of prolonging the current route when the current goes through the immovable contact. Therefore the capacity of the immovable contact will decrease and improve the transmission preference of the electrical connector in high frequency signal transmission.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a plan view of an immovable contact of an electrical connector according to a prior art;

FIG. 2 is an assembled view of an electrical connector according to the present invention;

FIG. 3 is a perspective view of a housing of the electrical connector showing in FIG. 2;

FIG. 4 is a perspective view of a shield of the electrical connector showing in FIG. 2;

FIG. 5 is a perspective view of a movable contact of the electrical connector showing in FIG. 2;

FIG. 6 is a perspective view of an immovable contact of the electrical connector showing in FIG. 2; and

FIG. 7 is a plan view of the immovable contact of the electrical connector.

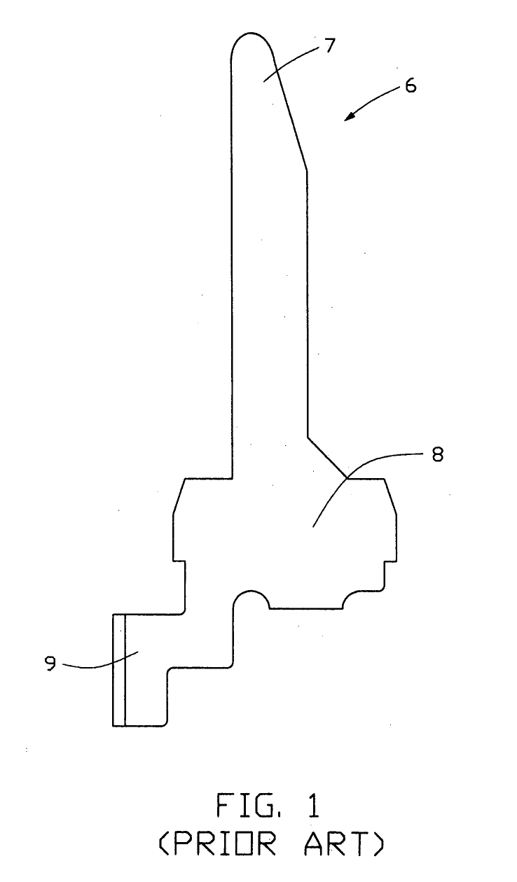

### DETAILED DESCRIPTION OF THE INVENTION

Reference will now be made in detail to the preferred embodiment of the present invention.

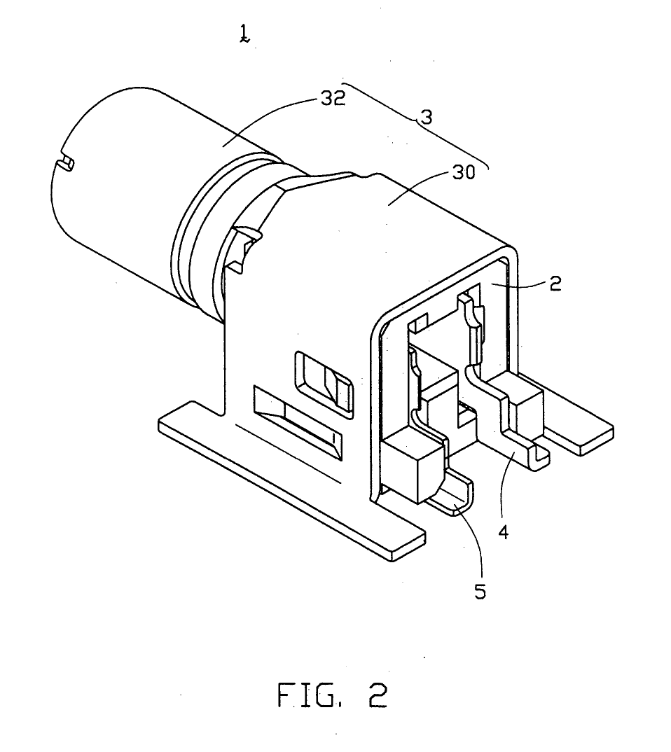

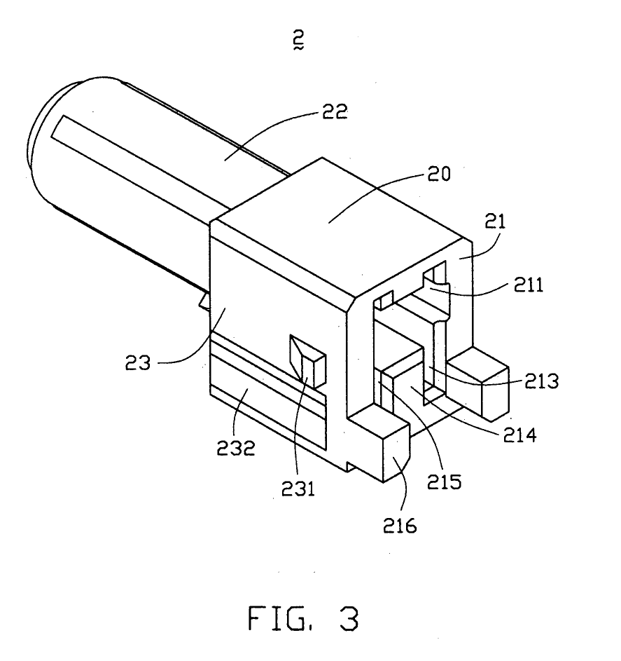

As shown in FIGS. 2-3, an electrical connector 1 adapted for mounting on a printed circuit board (not shown) according to the present invention includes an insulative housing 2, a metal outer shield 3 enclosing the housing 2, a movable contact 4 and an immovable contact 5 retained in the housing 2. The housing 2 includes a substantially cubic main body 20 and a generally columnar portion 22 forwardly extending from the main body 20.

As depicted in FIG. 3, the cubic main body 20 of the housing 2 comprises a back wall 21 and a pair of sidewalls 23. The back wall 21 defines a receiving cavity 211 thereof. A vertical partition 214 upwardly projects from a substantially middle of a bottom surface of the receiving cavity 211, thereby forming a first groove 213 for receiving the movable contact 4 and a second groove 215 for receiving the immovable contact 5. A pair of posts 216 backwardly extends from opposite sides of the back wall 21 for further resisting the movable contact 4 and the immovable contact 5, as will be more detailed hereinafter. Each sidewall 23 forms a protrusion 231 positioned in a back portion thereof adjacent to the back wall 21 and defines a channel 232 located in a bottom portion thereof.

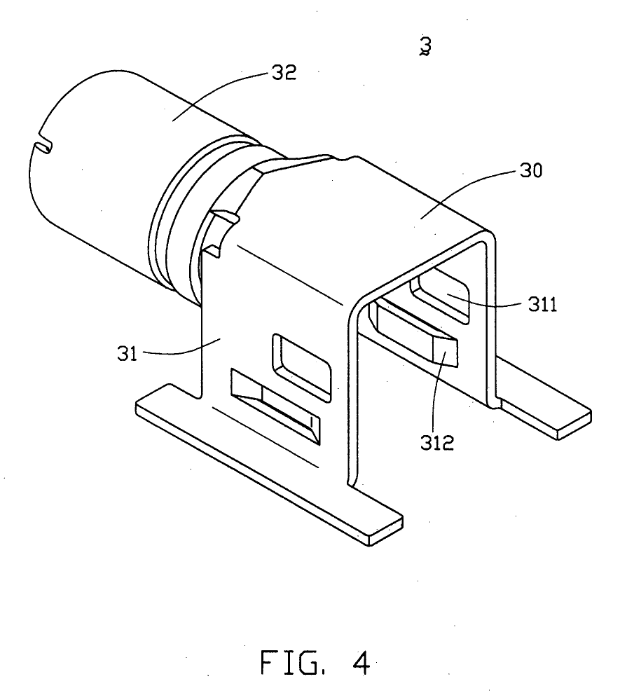

Referring to in FIG. 4, the metal outer shield 3 is substantially similar to the insulative housing 2 in shape. The shield 3 includes a back portion 30 appropriately enclosing the cubic main body 20 of the housing 2 and a columnar front portion 32 preferably shielding the columnar front portion 22 of the housing 2. The back portion 30 includes a pair of sidewalls 31 each defining a notch 311 for appropriately exposing the protrusion 231 of the housing 2 and a projection 312 interiorly depressing for interferentially fixing with the channel 232 of the housing 2.

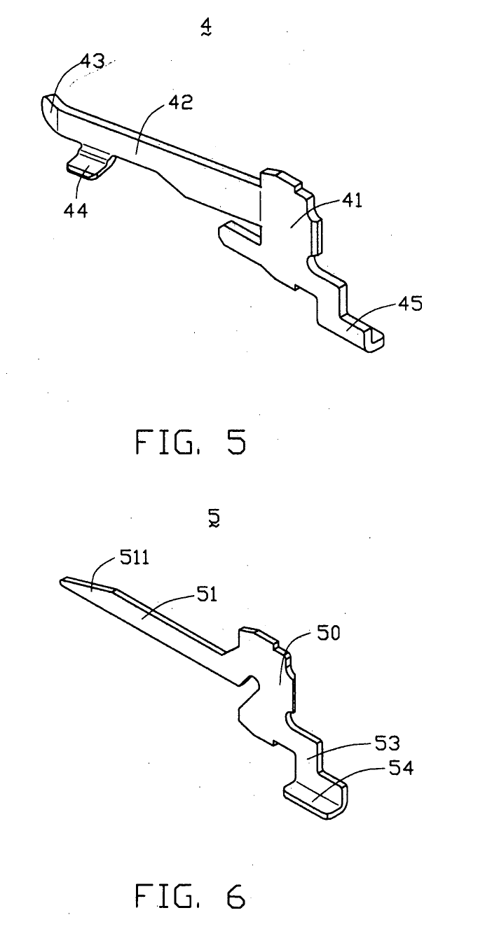

Referring to FIG. 5, the movable contact 4 includes a fixing portion 41, a cantilevered beam 42 longitudinally extending from the fixing portion 41, a lead-in portion 43 formed in a free end of the cantilevered beam 42 for preferably engaging with a complementary connector (not shown), a step-shaped soldering portion 45 backwardly extending from the fixing portion 41. A tab 44 transversely extends from a front portion of the cantilevered beam 42.

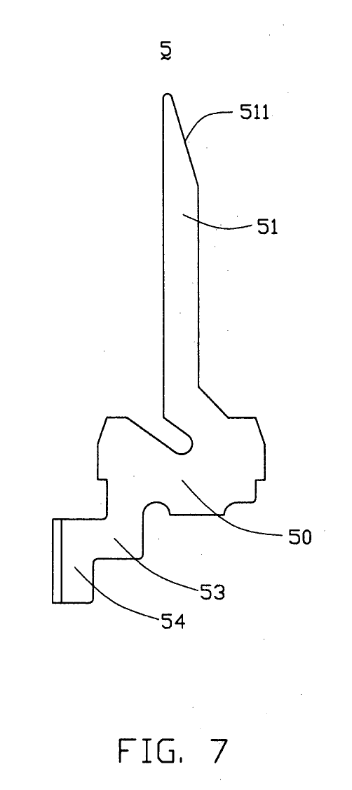

Referring to FIG. 6 in conjunction with FIG. 7, the immovable contact 5 includes a main body 50, a cantilevered arm 51 longitudinally extending from the main body 50, a right angle soldering portion 53 backwardly extending from the main body 50. The main body 50 is a substantially “Z” shape to prolong the current route and to cut the area of the immovable contact 5, thereby decreasing the capacitance of the immovable contact 5. The cantilevered arm 51 forms a taper portion 511 in a free end thereof for conveniently inserting the immovable contact 5 into the second groove 215. The cantilevered arm 51 forms an angle with the fixing portion 50. The soldering portion 53 is substantially step-shaped and has a horizontal portion 54 for being soldering to the printed circuit board.

Referring to FIGS. 2-6, in assembly, firstly, the cantilevered beam 42 of the movable contact 4 and the cantilevered arm 51 of the immovable contact 5 are respectively inserted into the first groove 213 and the second groove 215 of the insulative housing 2. Secondly, the movable and immovable contacts 4, 5 are completely inserted into the first and second grooves 212, 213. The stepped-shape soldering portion 45, 53 respectively abut against the corresponding posts 216 of the housing 2 and space from each other. Finally, the metal outer shield 3 is assembled on the housing 2 with the protrusions 231 of the housing 2 engaging with the corresponding notches 311 of the shield 3 and the channels 232 of the housing 2 engaging with the projections 312 of the shield 3.

As depicted in FIG. 7 in conjunction with FIG. 5, in use, the current flows from the movable contact 4 to the immovable contact 5 through the tab 44 of the movable contact 4. Due to the Z shaped fixing portion 50 of the immovable contact 5, the current through the immovable contact 5 will go through a longer route, thereby decreasing the capacity of the immovable contact 5 and further obtaining better transmission preference. In addition, due to the Z-shaped fixing portion 50, the area of immovable contact 5 is relatively small, thereby further impairing the capacity of the immovable contact 5.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. An electrical connector adapted for mounting on a printed circuit board, comprising:
a housing defining a receiving cavity;
a metal outer shield shielding the housing;
an immovable contact retained in the cavity of the housing and having a substantially Z-shape main body, a cantilevered arm longitudinal extending from the main body and a soldering portion backwardly extending from the fixing portion; and
a movable contact retained in the cavity of the housing.

2. The electrical connector according to claim 1, wherein the cantilevered arm forms an angle with the main body of the immovable contact.

3. The electrical connector according to claim 1, wherein the soldering portion of the immovable contact is substantially right-angle shaped.

4. The electrical connector according to claim 1, wherein the housing defines a first and a second grooves for respectively receiving the movable and the immovable contacts.

5. The electrical connector according to claim 1, wherein the movable contact comprises a fixing portion, a cantilevered beam longitudinally extending from the fixing portion and a soldering portion backwardly extending from the fixing portion.

6. The electrical connector according to claim 5, wherein the movable contact further includes a tab transversely extending from the cantilevered beam and contacting with the cantilevered arm of the immovable contact.

7. An electrical connector adapted for mounting on a printed circuit board comprising:
a housing defining a receiving cavity;
a metal outer shield shielding the housing;
an immovable contact retained in the cavity of the housing and having a main body with retention means for fixing the immovable contact in the housing, a cantilevered arm longitudinal forwardly extending from the main body and a soldering portion backwardly extending from the fixing portion; and
a movable contact retained in the cavity of the housing; wherein
said main body defines a slot to form an extension section, which the cantilevered arm extends from and has a similar width with the cantilevered arm.

8. The connector as claimed in claim 7, wherein said cantilevered arm extends in a horizontal direction at a lever which is located between the extension section and said soldering portion.

9. An electrical connector adapted for mounting on a printed circuit board, comprising:
a housing defining a receiving cavity;
a metal outer shield shielding the housing;
an immovable contact retained in the cavity of the housing and having a main body with retention means for fixing the immovable contact in the housing, a cantilevered arm longitudinal forwardly extending from the main body and a soldering portion backwardly extending from the fixing portion;
a movable contact retained in the cavity of the housing; and
said main body defining a slot to form an extension section, from which the cantilevered arm extends; wherein
said cantilevered arm extends in a horizontal direction at a lever which is located between the extension section and said soldering portion.
